(19) United States
(12) Patent Application Publication
(10) Pub. No.: US 2008/0240617 A1
(43) Pub. Date: Oct. 2, 2008

(54) INTERPOLATION FRAME GENERATING APPARATUS, INTERPOLATION FRAME GENERATING METHOD, AND BROADCAST RECEIVING APPARATUS

(75) Inventor: KENICHI DOUNIWA, Asaka-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/042,548

(22) Filed: Mar. 5, 2008

(30) Foreign Application Priority Data
Mar. 30, 2007 (JP) 2007-092092

(51) Int. Cl. G06K 9/32; H04N 5/455

(52) U.S. Cl. 382/300; 348/726; 348/E05.113

(57) ABSTRACT

According to one embodiment, there is provided an interpolation frame generating apparatus including a detecting unit which obtains a first frame image and a second frame image continuously following the first frame image from an imparted image signal, compares the first frame image and the second frame image in a luminance component and a color-difference component, and detects a motion vector based on a comparison result, and a generating unit which generates an interpolating motion vector from the motion vector detected by the detecting unit, and generates an interpolation frame image based on the first frame image, the second frame image, and the interpolating motion vector.

### CROSS-REFERENCE TO RELATED APPLICATION

This application is based upon and claims the benefit of priority from Japanese Patent Application No. 2007-092092, filed Mar. 30, 2007, the entire contents of which are incorporated herein by reference.

### BACKGROUND

1. Field

One embodiment of the present invention relates to an interpolation frame generating apparatus, an interpolation frame generating method, and a broadcast receiving apparatus for detecting a motion vector using not only a luminance component but also a color-difference component.

2. Description of the Related Art

As is well known, with progress and spread of a digital imaging technology, many pieces of digital image processing apparatus including a digital broadcast receiving apparatus are developed and used. In such pieces of digital image processing apparatus, for example, there is known a technique of inserting an interpolation image into a frame image to make motion of a dynamic picture image look natural.

Jpn. Pat. Appln. KOKAI Publication No. 2005-6275 discloses a technique of generating an interpolation frame based on a motion vector of an image block constituting an image frame. In the technique, a motion-compensating vector of a coding block is used as the motion vector of the image block, whereby the motion vector is detected to generate the interpolation frame.

However, in the technique disclosed in Jpn. Pat. Appln. KOKAI Publication No. 2005-6275, comparison processing of the image frames is performed to a luminance signal to detect the motion vector while the comparison processing of the image frames is not performed to a color-difference signal. Accordingly, sometimes the motion vector cannot correctly be detected and the video picture fails, when the motion vector is detected only using a Y component for images in which the color-difference components differ from each other in a Cb component and a Cr component although the luminance components are identical to each other.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an example of a configuration of an interpolation frame generating apparatus according to an embodiment of the invention;

FIG. 2 is a block diagram showing an example of a configuration of a motion vector detecting unit used in the interpolation frame generating apparatus of the embodiment;

FIG. 3 is a block diagram showing another example of a configuration of the motion vector detecting unit used in the interpolation frame generating apparatus according to an embodiment of the invention;

FIG. 4 is an explanatory view showing an example of interpolation processing performed by the interpolation frame generating apparatus of the embodiment using motion vectors of Cb and Cr components;

FIG. 5 is a flowchart showing an example of the interpolation processing of the interpolation frame generating apparatus of the embodiment;

FIG. 6 is a flowchart showing an example of interpolation processing accompanied with processing of thinning out the Cb and Cr components, performed by the interpolation frame generating apparatus of the embodiment;

FIG. 7 is a flowchart showing an example of interpolation processing performed by the interpolation frame generating apparatus of the embodiment in which the motion vectors of the Cb and Cr components are used based on a difference between a first candidate and a second candidate;

FIG. 8 is a flowchart showing an example of interpolation processing accompanied with processing of thinning out the Cb and Cr components based on a difference between a first candidate and a second candidate, performed by the interpolation frame generating apparatus of the embodiment; and

FIG. 9 is a block diagram showing an example of a configuration of a broadcast receiving apparatus including an image processing unit in which a dynamic characteristic improving unit provided with the interpolation frame generating apparatus of the embodiment is used.

### DETAILED DESCRIPTION

Various embodiments according to the invention will be described hereinafter with reference to the accompanying drawings. In general, according to one embodiment of the invention, an interpolation frame generating apparatus comprising: a detecting unit which obtains a first frame image and a second frame image continuously following the first frame image from an imparted image signal, compares the first frame image and the second frame image in a luminance component and a color-difference component, and detects a motion vector based on a comparison result; and a generating unit which generates an interpolating motion vector from the motion vector detected by the detecting unit, and generates an interpolation frame image based on the first frame image, the second frame image, and the interpolating motion vector.

In view of the foregoing, an embodiment of the invention provides an interpolation frame generating apparatus, an interpolation frame generating method, and a broadcast receiving apparatus for being able to provide an interpolation image with little failure of the video picture by detecting the motion vector for not only the luminance signal but also the color-difference signal.

One embodiment for achieving the object is an interpolation frame generating apparatus comprising:

a detecting unit (3) which obtains a first frame image (F1) and a second frame image (F2) continuously following the first frame image from an imparted image signal, compares the first frame image and the second frame image in a luminance component and a color-difference component, and detects a motion vector (V1) based on a comparison result; and

a generating unit (5) which generates an interpolating motion vector (V2) from the motion vector (V1) detected by the detecting unit, and generates an interpolation frame image (F3) based on the first frame image, the second frame image, and the interpolating motion vector.

Therefore, because an error is hardly generated in the motion vector by detecting the motion vector for not only the luminance signal but also the color-difference signal of the Cb and Cr components, when the invention is applied to the broadcast receiving apparatus, the dynamic picture image can be displayed by the interpolation image having little failure of the video picture.

A preferred embodiment of the invention will be described in detail with reference to the drawings.

<Interpolation Frame Generating Apparatus According to One Embodiment of the Invention>

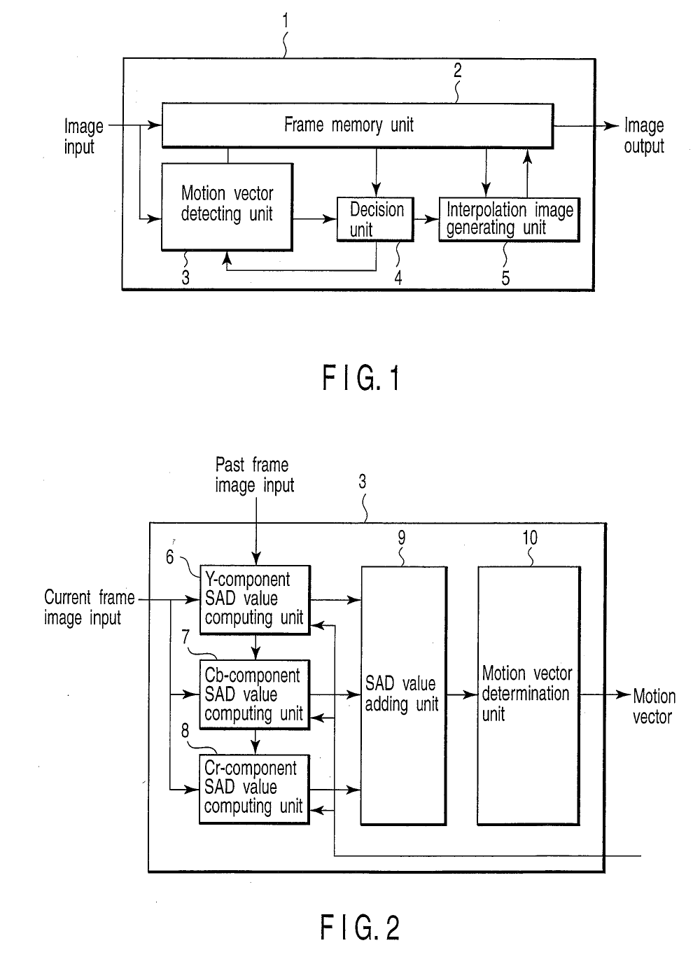

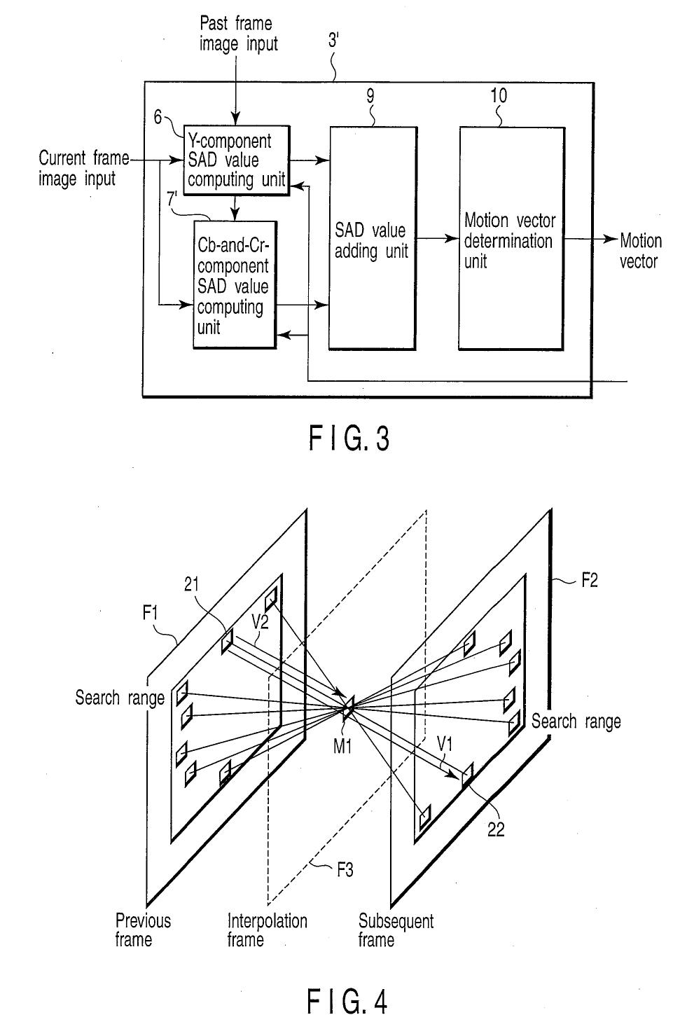

First, an interpolation frame generating apparatus according to an embodiment of the invention will be described in detail with reference to the drawings. FIG. 1 is a block diagram showing an example of a configuration of an interpolation frame generating apparatus of the embodiment. FIG. 2 is a block diagram showing an example of a configuration of a motion vector detecting unit used in the interpolation frame generating apparatus of the embodiment. FIG. 3 is a block diagram showing another example of a configuration of the motion vector detecting unit used in the interpolation frame generating apparatus according to an embodiment of the invention.

(Configuration)

As shown in FIG. 1, an interpolation frame generating apparatus 1 of the embodiment includes a frame memory unit 2, a motion vector detecting unit 3, a decision unit 4, and an interpolation image generating unit 5. An imparted frame image is stored in the frame memory unit 2. The motion vector detecting unit 3 detects the Y component which is the luminance signal and the Cb component and Cr component which are the color-difference signal. The decision unit 4 compares SAD values of plural macro blocks of the motion vector to make a decision of probability of vector detection. The interpolation image generating unit 5 generates the interpolation image based on the first frame image, the second frame image, and the motion vector.

As shown in FIG. 2, the motion vector detecting unit 3 includes a Y-component SAD value computing unit 6 computing the SAD value of the Y component which is the luminance signal, a Cb-component SAD value computing unit 7 computing the SAD value of the Cb component which is the color-difference component, a Cr-component SAD value computing unit 8 computing the SAD value of the Cr component which is the color-difference component, a SAD value adding unit 9 summing the SAD values, and a motion vector determination unit 10 determining a motion vector V1 based on computation result of the SAD value adding unit 9.

As shown in FIG. 3, a motion vector detecting unit 3′ according to another embodiment of the invention includes the Y-component SAD value computing unit 6 computing the SAD value of the Y component which is the luminance signal, a Cb-and-Cr-component SAD value computing unit 7′ computing the SAD values of the Cb and Cr components which are the color-difference component only for an arbitrary pixel (thinning-out processing), the SAD value adding unit 9 summing the SAD values, and the motion vector determination unit 10 determining the motion vector V1 based on the computation result of the SAD value adding unit 9.

The interpolation frame generating apparatus 1 having the above-described configuration performs interpolation processing as follows.

(Interpolation Processing)

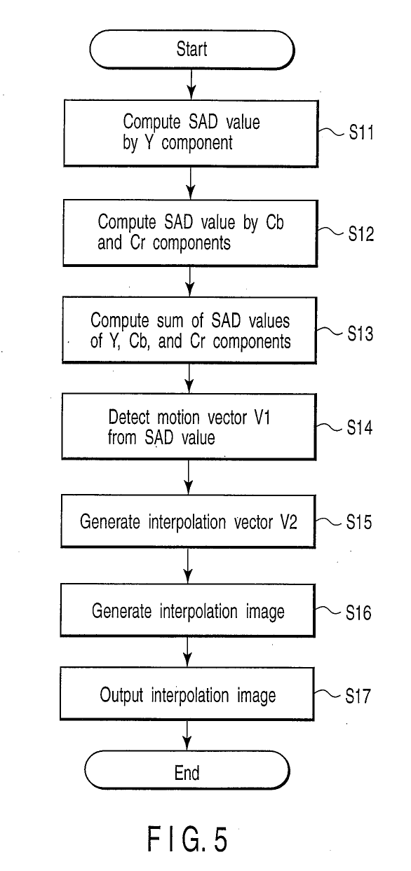

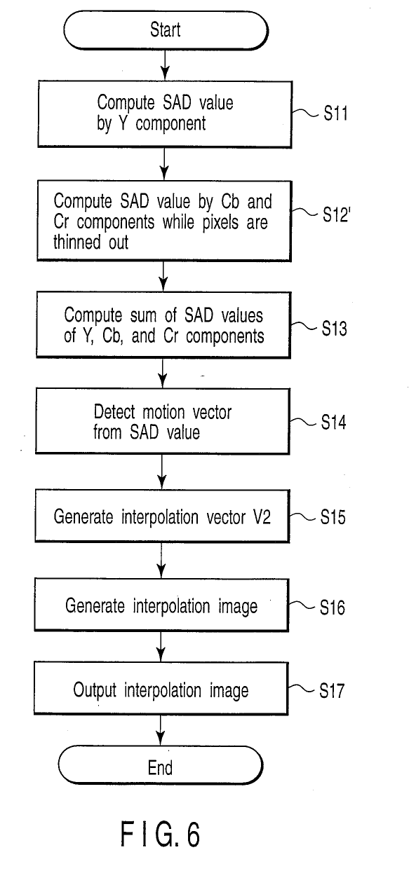

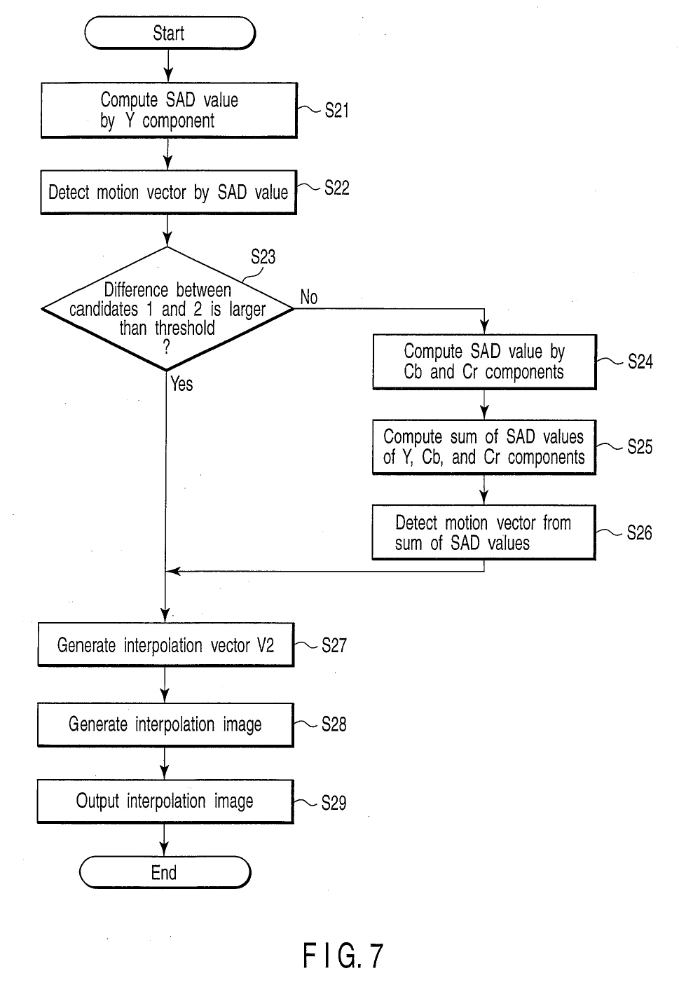

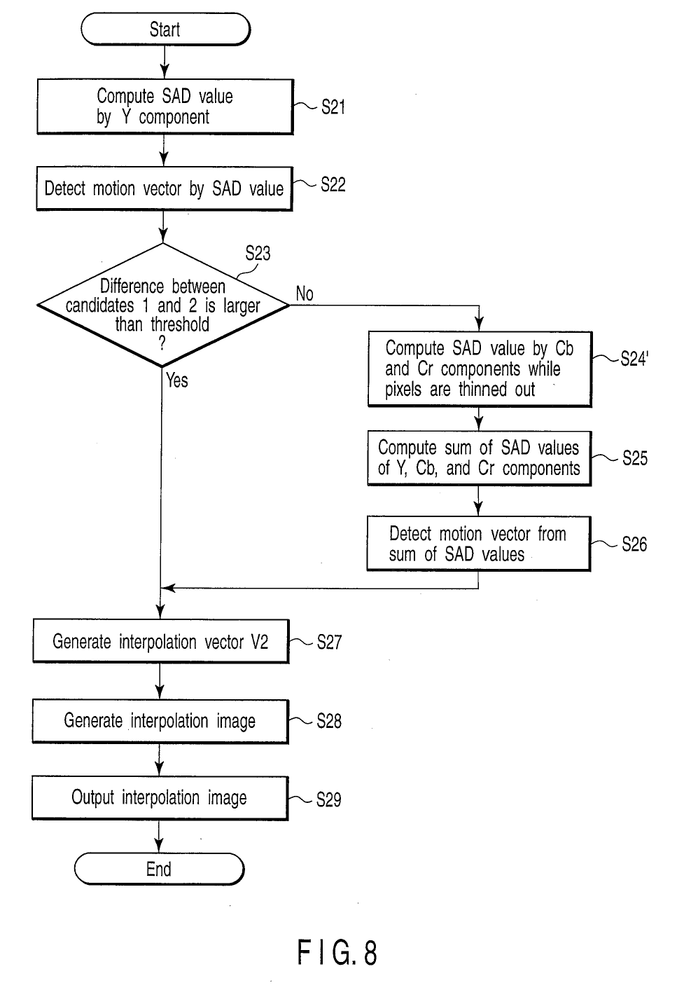

The interpolation processing performed by the interpolation frame generating apparatus 1 of the embodiment will be described in detail with reference to the drawings. FIG. 4 is an explanatory view showing an example of the interpolation processing performed by the interpolation frame generating apparatus of the embodiment using the motion vectors of the Cb and Cr components. FIG. 5 is a flowchart showing an example of the interpolation processing of the interpolation frame generating apparatus of the embodiment. FIG. 6 is a flowchart showing an example of the interpolation processing accompanied with processing of thinning out the Cb and Cr components. FIG. 7 is a flowchart showing an example of the interpolation processing in which the motion vectors of the Cb and Cr components are used based on a difference between a first candidate and a second candidate. FIG. 8 is a flowchart showing an example of the interpolation processing using the motion vector accompanied with processing of thinning out the Cb and Cr components based on a difference between a first candidate and a second candidate. Each of Steps in flowcharts shown in FIGS. 5 to 8 can be replaced by a circuit block, and therefore Steps of each flowchart can be re-defined as the circuit blocks.

(Interpolation Processing by Detection of Motion Vector including Color-Difference Component: FIG. 5)

The interpolation processing by detection of the motion vector including the color-difference component will be described in detail with reference to the flowchart of FIG. 5. First, as shown in the flowchart of FIG. 5, in the interpolation frame generating apparatus 1, a video picture signal having the Y component, Cb component, and Cr component is supplied from the outside to the frame memory unit 2 and motion vector detecting unit 3.

Then, the motion vector detecting unit 3 computes the SAD (Sum of Absolute Difference) values in each of plural macro blocks constituting an interpolation frame F3 of FIG. 4.

As used herein, the SAD value shall mean an index of block matching processing. The plural macro blocks into which the interpolation frame F3 is divided are assumed in the block matching. As shown in FIG. 4, an absolute difference in luminance Y is determined between the pixel of the macro block of a target previous frame F1 and the pixel of the macro block of a subsequent frame F2 with respect to one macro block M1 in the plural macro blocks, and the sum of absolute differences, i.e., the SAD value is determined.

The motion vector detecting unit 3 performs the block matching processing, and the Y-component SAD value computing unit 6 computes the SAD value of each macro block with respect to the macro block M1 located on the interpolation frame F3 using the Y component (Step S11). Then, the Cb-component SAD value computing unit 7 computes the SAD value of each macro block using the Cb component, and the Cr-component SAD value computing unit 8 computes the SAD value of each macro block using the Cr component (Step S12). Then, the SAD value computing unit 8 shown in FIG. 2 computes the sum of SAD values of the Y component, Cb component, Cr component (Step S13).

As shown in FIG. 4, on the basis of the addition result, the motion vector determination unit 10 shown in FIG. 2 determines the motion vector V1 using the minimum SAD value (Step S14).

Then, the decision unit 4 decides and generates an interpolating motion vector V2 from the motion vector V1 (Step S15). The interpolation image generating unit 5 generates the interpolation frame F3 from the interpolating motion vector V2 and the previous and subsequent frames F1 and F2 stored in the frame memory unit 2 (Step S16). The interpolation frame F3 is inserted between the previous frame F1 and the subsequent frame F2 and outputted to the subsequent stage (Step S17).

Thus, in the interpolation frame generating apparatus 1 of the embodiment, the block matching processing is performed to not only the luminance signal but also the color-difference signal to obtain the SAD value, and the addition is performed to determine the motion vector. Therefore, even if the color difference is changed while the luminance is not changed, the correct motion vector is surely obtained, so that the interpolation frame can correctly be generated according to the change in color difference.

(Interpolation Processing by Detection of Motion Vector including Thinned-Out Color-Difference Component: FIG. 6)

In the detection of the motion vector including the color-difference component of FIG. 5, because the computation is performed to not only the luminance component but also the color-difference component, a processing load triples. In interpolation processing of FIG. 6, the motion vector including a thinned-out color-difference component is detected to reduce the increased processing load.

The same processing as the flowchart of FIG. 5 is omitted. In Step S12′ of the flowchart of FIG. 6, the Cb-and-Cr-component SAD value computing unit 7′ of the motion vector detecting unit 3′ computes only a 1/N component in an x-direction for the Cb and Cr components on a small region. The Cb-and-Cr-component SAD value computing unit 7′ computes a 1/M component in a y-direction. In Step S13, desirably the SAD value is multiplied by NM to obtain the sum because the SAD values of the Cb and Cr components are thinned out to 1/NM.

The thinning-out processing of the block matching process with the color-difference signal is not limited to the embodiment, but any method of reducing the processing load is suitable to the thinning-out processing.

Thus, in the flowchart of FIG. 6, by performing the 1/NM thinning-out processing, the detection of the motion vector is realized in consideration of not only the luminance component but also the color-difference component while the load on the computation processing of the color-difference component is reduced.

(Interpolation Process in Which Motion Vector of Color-Difference Component is Detected Under Constant Condition: FIG. 7)

As shown in a flowchart of FIG. 7, in the detection of the motion vector of the color-difference component under a constant condition, the detection of the motion vector of the color-difference component which increases the processing load is performed only under the constant condition to reduce the whole of the processing load.

In the flowchart of FIG. 7, only the Y-component SAD value computing unit 6 computes the SAD value of the Y component under the control of the decision unit 4 (Step S21). The motion vector determination unit 10 detects the motion vector based on the computation result of the Y-component SAD value computing unit 6 (Step S22). In Step S23, in plural candidates of the small regions, a difference in SAD value between a first candidate having the smallest SAD value and a second candidate having the second smallest SAD value is compared with a predetermined threshold. When the difference in SAD value is larger than the threshold, the detection of the motion vector by the color-difference component is not required, and the flow goes to Step S27.

When the difference in SAD value is smaller than the threshold in plural candidates of the small regions, it is decided that the detection of the motion vector by the color-difference component is required, and the flow goes to Step S24.

The Cb-component SAD value computing unit 7 and the Cr-component SAD value computing unit 8 compute the SAD value of the color-difference component by the decision and control of the decision unit 4 (Step S24). The SAD values of the Cb and Cr components and the SAD value of the luminance component are summed (Step S25), and the motion vector is detected by the sum (Step S26).

Then, the decision unit 4 decides and generates the interpolating motion vector V2 from the motion vector V1 (Step S27). The interpolation image generating unit 5 generates the interpolation frame F3 from the interpolating motion vector V2 and the previous and subsequent frames F1 and F2 stored in the frame memory unit 2 (Step S28). The interpolation frame F3 is inserted between the previous frame F1 and the subsequent frame F2 and outputted to the subsequent stage (Step S29).

Therefore, only in the case of the slightly small difference between the first candidate and second candidate in the small regions, the SAD value of the color-difference component which becomes the processing load is computed to detect the correct motion vector. This enables a balance to be achieved-between the reduction of the processing load and the secure detection of the vector.

(Interpolation Process in Which Motion Vector Including Thinned-Out Color-Difference Component is Detected Under Constant Condition: FIG. 8)

As shown in a flowchart of FIG. 8, in the detection of the motion vector including the thinned-out color-difference component under a constant condition, the thinned-out color-difference component is detected only under the constant condition to further reduce the processing load compared with the processing of FIGS. 6 and 7.

The same processing as the flowchart of FIG. 7 is omitted. In Step S23 in the flowchart of FIG. 8, in the plural candidates of the small regions, the difference in SAD value between a first candidate having the smallest SAD value and a second candidate having the second smallest SAD value is compared with a predetermined threshold. When the difference in SAD value is smaller than the threshold, it is decided that the detection of the motion vector by the color-difference component is required, and the flow goes to Step S24′.

The Cb-component SAD value computing unit 7 and the Cb-and-Cr-component SAD value computing unit 7′ compute the SAD value of the color-difference component, thinned out to 1/NM, by the decision and control of the decision unit 4 (Step S24′). The SAD values of the color-difference components, thinned out to 1/NM, and the SAD value of the luminance component are summed (Step S25). At this point, because the SAD values of the color-difference components and the SAD value of the Cb and Cr components are thinned out to 1/NM in Step S24′, preferably the SAD values of the color-difference components are multiplied by NM to obtain the sum. Then, the motion vector is detected from the sum (Step S26).

Thus, only in the case of the slightly small difference between the first candidate and second candidate in the small regions, the SAD value of the thinned-out color-difference component is computed to detect the correct motion vector. Therefore, the vector can surely be detected while the processing load is further reduced compared with the processing of FIG. 7.

<Broadcast Receiving Apparatus to Which Interpolation Frame Generating Apparatus According to One Embodiment of the Invention is Applied>

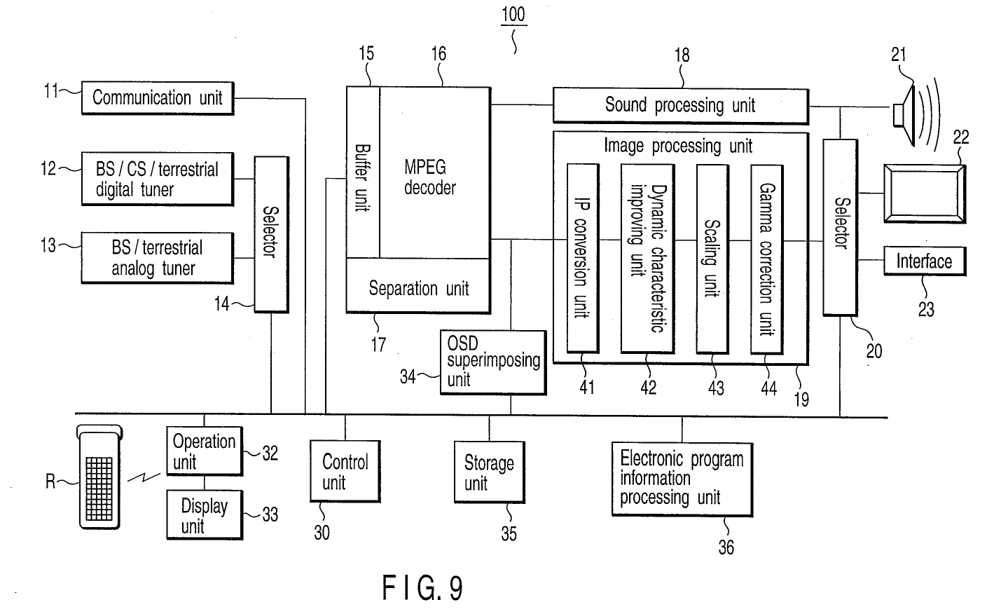

An example of a broadcast receiving apparatus to which the interpolation frame generating apparatus according to one embodiment of the invention is applied will be described below with reference to the drawing. FIG. 9 is a block diagram showing an example of a configuration of the broadcast receiving apparatus including an image processing unit in which a dynamic characteristic improving unit provided with the interpolation frame generating apparatus of the embodiment is used.

In a broadcast receiving apparatus 100, the interpolation frame generating apparatus 1 is suitably used as a dynamic characteristic improving unit 42 of an image processing unit 19.

(Configuration and Operation of Broadcast Receiving Apparatus)

A configuration of the broadcast receiving apparatus such as a digital television set which is an example of the broadcast receiving apparatus provided with the interpolation frame generating apparatus of the embodiment will be described in detail with reference to the drawing. FIG. 9 is a block diagram showing an example of the configuration of the broadcast receiving apparatus such as the digital television set to which the interpolation frame generating apparatus of the embodiment is applied.

As shown in FIG. 9, the broadcast receiving apparatus 100 is a television set by way of example, and a control unit 30 is connected to each unit through a data bus to control the whole operation. The broadcast receiving apparatus 100 is mainly formed by an MPEG decoder 16 constituting a reproduction side and the control unit 30 controlling the operation of the apparatus main body. The broadcast receiving apparatus 100 includes an input-side selector 14 and an output-side selector 20. A BS/CS/terrestrial digital tuner 12 and a BS/terrestrial analog tuner 13 are connected to the input-side selector 14. A communication unit 11 having LAN and mailing functions is provided and connected to the data bus.

The broadcast receiving apparatus 100 also includes a buffer unit 15, a separation unit 17, the MPEG decoder 16, and an OSD (On Screen Display) superimposing unit 34. A demodulated signal from the BS/CS/terrestrial digital tuner is temporarily stored in the buffer unit 15. The separation unit 17 separates packets, which are the demodulated signals stored, according to each type. The MPEG decoder 16 outputs video picture and sound signals by performing MPEG decode processing to the video picture and sound packets supplied from the separation unit 17. The OSD superimposing unit 34 generates a video picture signal for superimposing operation information, and superimposes the video picture signal for superimposing operation information onto the video picture signal. The broadcast receiving apparatus 100 also includes a sound processing unit 18, an image processing unit 19, a selector 20, a speaker 21, a display unit 22, and an interface 23. The sound processing unit 18 performs amplification processing to the sound signal from the MPEG decoder 6. The image processing unit 19 receives the video picture signals from the MPEG decoder 16 and the OSD superimposing unit 34 to perform the desired image processing. The selector 20 selects outputs of the sound signal and video picture signal. The speaker 21 outputs the sound according to the sound signal from the sound processing unit 18. The display unit 22 is connected to the selector 20, and displays the video picture on a liquid crystal display screen according to the imparted video picture signal. The interface 23 conducts communication with an external device.

The image processing unit 19 includes an IP conversion unit 41, a dynamic characteristic improving unit 42, a scaling unit 43, and a gamma correction unit 44. The IP conversion unit 41 converts an interlace signal into a progressive signal. The dynamic characteristic improving unit 42 improves a dynamic characteristic of the video picture signal by inserting the interpolation image into the frame image using the interpolation frame generating unit 1. The scaling unit 43 performs scaling processing. The gamma correction unit 44 performs gamma correction of the video picture signal.

The broadcast receiving apparatus 100 also includes a storage unit 35 and an electronic program information processing unit 36. The pieces of video picture information and the like from the BS/CS/terrestrial digital tuner 12 and BS/terrestrial analog tuner 13 are appropriately recorded in the storage unit 35. The electronic program information processing unit 36 obtains electronic program information from a broadcast signal or the like to display the electronic program information on the screen. The storage unit 35 and the electronic program information processing unit 36 are connected to the control unit 30 through the data bus. The broadcast receiving apparatus 100 also includes an operation unit 32 and a display unit 33. The operation unit 32 is connected to the control unit 30 through the data bus to receive user operation or operation of a remote controller R. The display unit 33 displays an operation signal. The remote controller R can perform substantially the same operation as the operation unit 32 provided in the main body of the broadcast receiving apparatus 100, and various settings such as the tuner operation can be performed in the remote controller R.

In the thus configured broadcast receiving apparatus 100, the broadcast signal is inputted from a receiving antenna to the BS/CS/terrestrial digital tuner 12, and a channel is selected by the BS/CS/terrestrial digital tuner 12. The separation unit 17 separates the demodulated signal in the form of the packet into different types of the packets, the MPEG decoder 16 performs the decode processing to the video picture and sound packets to obtain the video picture and sound signals, and the video picture and sound signals are supplied to the sound processing unit 18 and the image processing unit 19. In the image processing unit 19, the IP conversion unit 41 converts the interlace signal into the progressive signal for the imparted video picture signal, and the dynamic characteristic improving unit 42 performs the interpolation frame processing in order that the video picture is smoothly moved. Then, the scaling unit 43 performs the scaling processing, the gamma correction unit 44 performs the gamma correction of the video picture signal, and the video picture signal is supplied to the selector 20.

The selector 20 supplies the video picture signal to the display unit 22 according to a control signal of the control unit 30, which allows the video picture to be displayed on the display unit 22 according to the video picture signal. The speaker 21 outputs the sound according to the sound signal from the sound processing unit 18.

Various pieces of operation information and closed-caption information generated by the OSD superimposing unit 34 are superimposed on the video picture signal according to the broadcast signal, and the corresponding video picture is displayed on the display unit 22 through the image processing unit 19.

In the dynamic characteristic improving unit 42 of the broadcast receiving apparatus 100, the interpolation frame is added by the interpolation frame generating unit 1, so that the video picture can be moved more smoothly and can naturally be displayed.

While the invention has been described with reference to the preferred embodiment thereof, it will be understood by those skilled in the art that the various changes and modifications can be made without departing from the spirit and scope of the invention and the invention can be applied to various embodiments with no inventive ability. Accordingly, the invention is not limited to the above embodiment, but covers a wide range consistent with the disclosed principle and novel features.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An interpolation frame generating apparatus comprising:
a detecting unit which obtains a first frame image and a second frame image continuously following the first frame image from an imparted image signal, compares the first frame image and the second frame image in a luminance component and a color-difference component, and detects a motion vector based on a comparison result; and
a generating unit which generates an interpolating motion vector from the motion vector detected by the detecting unit, and generates an interpolation frame image based on the first frame image, the second frame image, and the interpolating motion vector.

2. The interpolation frame generating apparatus according to claim 1, wherein the detecting unit performs comparison processing of the color-difference component while not all pixels of the first frame image and second frame image but a part of the pixels is used as a target.

3. The interpolation frame generating apparatus according to claim 1, wherein the detecting unit divides the interpolation frame image into a plurality of small regions,
the detecting unit determines each sum of absolute difference of a luminance component or a color-difference component between a plurality of regions of the first frame image and a plurality of regions of the second frame image for the small regions, and
the detecting unit compares the sums to detect the motion vector by detecting a combination having the minimum sum of a region of the first frame image and a region of the second frame image.

4. The interpolation frame generating apparatus according to claim 1, wherein the detecting unit divides the interpolation frame image into a plurality of small regions,
the detecting unit determines each sum of absolute difference by comparing luminance components of a plurality of small regions of the second frame image corresponding to a plurality of small regions of the first frame image for the small regions,
in comparing the plurality of sums to detect a combination of a region of the first frame image having the minimum sum and a region of the second frame image, when a difference between a first candidate and a second candidate is smaller than a threshold, the detecting unit determines a sum of absolute difference of a color-difference component between a plurality of small regions of the first frame image and a plurality of small regions of the second frame image corresponding to the first frame image, and
the detecting unit determines the motion vector by detecting a combination in which addition of the sum of absolute difference of the luminance component and the sum of absolute difference of the color-difference component becomes the minimum.

5. The interpolation frame generating apparatus according to claim 3, wherein the processing of determining the sum of color difference of the small region is performed while not all the pixels of the small regions of the first frame image and second frame image but a part of the pixels is used as a target.

6. A broadcast receiving apparatus comprising:
a tuner which demodulates a broadcast signal to output a demodulated signal;
a decoder which decodes the demodulated signal from the tuner to output a video picture signal;
a detecting unit which obtains a first frame image and a second frame image continuously following the first frame image from the video picture signal from the decoder, compares the first frame image and the second frame image in a luminance component and a color-difference component, and detects a motion vector based on a comparison result; and
a generating unit which generates an interpolating motion vector from the motion vector detected by the detecting unit, generates an interpolation frame image based on the first frame image, the second frame image, and the interpolating motion vector, and outputs the interpolation frame image while the interpolation frame image is inserted between the first frame image and the second frame image.

7. An interpolation frame generating method comprising:
obtaining a first frame image and a second frame image continuously following the first frame image from an imparted image signal;
comparing the first frame image and the second frame image in a luminance component and a color-difference component;
detecting a motion vector based on a comparison result;
generating an interpolating motion vector from the detected motion vector; and
generating an interpolation frame image based on the first frame image, the second frame image, and the interpolating motion vector.

8. The interpolation frame generating method according to claim 7, wherein, in detecting the motion vector, comparison processing of the color-difference component is performed while not all the first frame image and second frame image but a part thereof is used as a target.

9. The interpolation frame generating method according to claim 7, wherein the interpolation frame image is divided into a plurality of small regions,
sums of absolute difference of a luminance component or a color-difference component between a plurality of regions of the first frame image and a plurality of regions of the second frame image are determined for the small regions respectively, and
the sums are compared to detect a combination having the minimum sum of a region of the first frame image and a region of the second frame image, thereby detecting the motion vector.

10. The interpolation frame generating method according to claim 7, wherein, in detecting the motion vector, the interpolation frame image is divided into a plurality of small regions,
each sum of absolute difference is determined for the small regions by comparing luminance components of a plurality of small regions of the second frame image corresponding to a plurality of small regions of the first frame image,
in comparing the plurality of sums to detect a combination of a region of the first frame image having the minimum sum and a region of the second frame image, when a difference between a first candidate and a second candidate is smaller than a threshold, a sum of absolute difference of a color-difference component between a plurality of small regions of the first frame image and a plurality of regions of the second frame image corresponding to the first frame image is determined, and
the motion vector is determined by detecting a combination in which addition of the sum of absolute difference of the luminance component and the sum of absolute difference of the color-difference component becomes the minimum.
